(19) United States
(12) Patent Application Publication
(10) Pub. No.: US 2014/0115140 A1
(43) Pub. Date: Apr. 24, 2014

(54) Method, Apparatus, and System For Presenting Augmented Reality Technology Content

(71) Applicant: Huawei Device Co., Ltd., Shenzhen (CN)

(72) Inventor: Zhihao Jin, Beijing (CN)

(73) Assignee: Huawei Device Co., Ltd., Shenzhen (CN)

(21) Appl. No.: 14/138,464

(22) Filed: Dec. 23, 2013

Related U.S. Application Data
(63) Continuation of application No. PCT/CN2013/070251, filed on Jan. 9, 2013.

(30) Foreign Application Priority Data
Jan. 10, 2012 (CN) 201210006223.X

(51) Int. Cl. H04L 29/08

(52) U.S. Cl. CPC H04L 67/10
USPC 709/223

(57) ABSTRACT

A method, an apparatus, and a system for presenting augmented reality technology (AR) content, relates to the field of virtual reality technology, and solves a problem in the prior art that a user terminal may run into an error when receiving point of interest information because the user terminal does not have a capability required for presenting AR content in the point of interest information. The technical solution includes: obtaining point of interest information, where the point of interest information includes AR content and capability information corresponding to a capability required for presenting the AR content; querying, according to the capability information, whether a user terminal has the capability required for presenting the AR content.

### CROSS-REFERENCE TO RELATED APPLICATIONS

This application is a continuation of International Application No. PCT/CN2013/070251, filed on Jan. 9, 2013, which claims priority to Chinese Patent Application No. 201210006223.X, filed on Jan. 10, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to the field of virtual reality technologies, and in particular, to a method, an apparatus, and a system for presenting augmented reality technology content.

### BACKGROUND OF THE INVENTION

Augmented reality technology (AR) performs analog simulation, through technologies, on physical information (for example, visual information, sound, smell, and touch) that is hard to be experienced within a time span and space in the real world, and performs overlay in the real world for being perceived by human senses, so as to achieve a sense experience that transcends reality. For example, when taking a video or picture of a building through a camera, a user overlays an introduction of the building, or a name and contact information of the company owning the building on the video or picture. Further, for example, when shooting a sports car with a camera, a user overlays a three-dimensional view of an internal structure of the sports car on the image of the sports car.

In the AR technology of the prior art, a network server stores point of interest (POI) information, for example, longitude and latitude information of a hotel, and transportation, restaurant, and other information near the hotel. When a user terminal initiates an AR client set on the user terminal and obtains an identifier of the point of interest through the user terminal, the AR client uploads the obtained identifier of the point of interest to the network server, the network server sends the point of interest information corresponding to the identifier of the point of interest to the AR client, and the AR client presents AR content (for example, hotel booking information, restaurant menu and price, discount information of a mall, and a three-dimensional view of an internal structure of an automobile) in the point of interest information for being used by the user terminal. When using the point of interest information, the user terminal needs to have a corresponding device capability (for example, radio frequency identification) or a rendering capability (for example, a three-dimensional imaging capability).

During the implementation of embodiments of the present invention, the inventor finds that the prior art has at least the following problem:

As user terminals are different in types, device capabilities and rendering capabilities of the different user terminals are substantially different, so that the user terminal may run into an error when receiving point of interest information because the user terminal may not have a capability required for presenting AR content in the point of interest information.

### SUMMARY OF THE INVENTION

Embodiments of the present invention provide a method, an apparatus, and a system for presenting AR content, so as to solve a problem in the prior art that a user terminal may run into an error when receiving point of interest information because the user terminal may not have a capability required for presenting AR content in the point of interest information.

In order to achieve the above objectives, the embodiments of the present invention adopt the following technical solutions:

A method for presenting AR content includes: obtaining point of interest information, where the point of interest information includes AR content and capability information corresponding to a capability required for presenting the AR content; querying, according to the capability information, whether a user terminal has the capability required for presenting the AR content; and hiding the AR content or obtaining the capability required for presenting the AR content if the user terminal does not have the capability required for presenting the AR content.

A user terminal includes: an obtaining unit configured to: obtain point of interest information, where the point of interest information includes AR content and capability information corresponding to a capability required for presenting the AR content; a querying unit configured to query, according to the capability information, whether a user terminal has the capability required for presenting the AR content; and a processing unit configured to hide the AR content or obtain the capability required for presenting the AR content if the user terminal does not have the capability required for presenting the AR content.

A system for presenting AR content includes the user terminal and a server configured to enable the user terminal to download point of interest information.

In the method, the apparatus, and the system provided by the embodiments of the present invention, point of interest information is obtained, whether a user terminal has the corresponding capability is queried according to capability information corresponding to a capability required for presenting AR content in the point of interest information, and the AR content is hidden or the capability required for presenting the AR content is obtained if the user terminal does not have the capability required for presenting the AR content. By using the method, an error does not occur during running on the user terminal after the user terminal receives the point of interest information. Compared with the prior art, the embodiments of the present invention may solve the problem that, when the user terminal that needs to present the AR content runs the point of interest information after it receives the point of interest information, an error occurs because the user terminal does not have the capability required for presenting the AR content.

### BRIEF DESCRIPTION OF THE DRAWINGS

To illustrate the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of a method for presenting AR content according to an embodiment of the present invention;

FIG. 2 is a flowchart of another method for presenting AR content according to an embodiment of the present invention;

FIG. 3 is a schematic structural diagram 1 of a user terminal according to an embodiment of the present invention;

FIG. 4 is a schematic structural diagram 2 of a user terminal according to an embodiment of the present invention;

FIG. 5 is a schematic structural diagram of a system for presenting AR content according to an embodiment of the present invention; and

FIG. 6 is a schematic structural diagram of a portable communication device according to an embodiment of the present invention.

### DETAILED DESCRIPTION OF THE EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

In order to make advantages of the technical solutions of the present invention more comprehensible, a detailed description of the present invention is given below with reference to the accompanying drawings and embodiments.

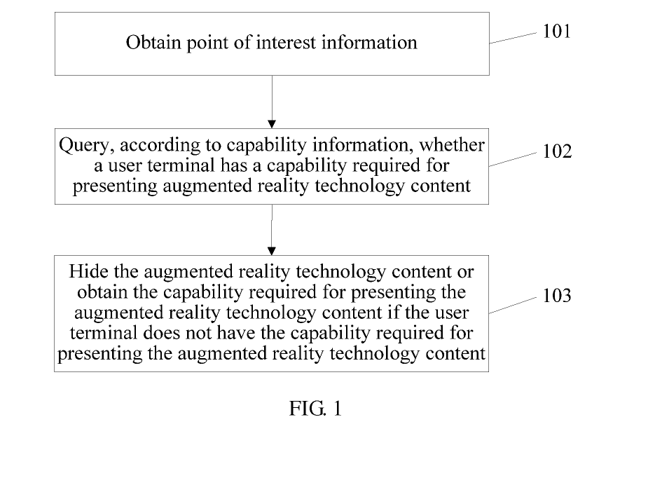

As shown in FIG. 1, a method for presenting AR content provided by an embodiment of the present invention includes:

Step 101: Obtain point of interest information.

The point of interest information may include AR content and capability information corresponding to a capability required for presenting the AR content.

Here, the AR content refers to information related to the point of interest presented to a user in the AR technology, such as hotel book information, restaurant menu and price, discount information of a mall, and a three-dimensional diagram of an internal structure of an automobile.

Step 102: Query, according to the capability information, whether a user terminal has the capability required for presenting the AR content.

The having the capability required for presenting the AR content may include: having the device capability that is required for presenting the AR content, where the device capability is enabled, or having a rendering capability required for presenting the AR content.

The device capability refers to that a user terminal owns corresponding devices (for example, a camera, a global positioning system, an acceleration sensor, a compass, and a radio frequency identification device), and the rendering capability refers to that the user terminal has a corresponding rendering imaging function (for example, a three-dimensional imaging function).

Step 103: Hide the AR content or obtain the capability required for presenting the AR content if the user terminal does not have the capability required for presenting the AR content.

The user terminal may be a cell phone, a computer, a tablet personal computer (PC), and the like, but the present invention is not limited hereto.

In the method for presenting AR content provided by the embodiment of the present invention, point of interest information is obtained, whether a user terminal has the corresponding capability is queried according to capability information corresponding to a capability required for presenting AR content in the point of interest information, and the AR content is hidden or the capability required for presenting the AR content is obtained if the user terminal does not have the capability required for presenting the AR content. By using the method, an error does not occur during running on the user terminal after the user terminal receives the point of interest information. Compared with the prior art, the embodiment of the present invention may solve the problem that, when the user terminal that needs to present the AR content runs the point of interest information after it receives the point of interest information, an error occurs because the user terminal does not have the capability required for presenting the AR content.

In order to make the embodiment of the present invention more comprehensible, the following describes the embodiment of the present invention in detail.

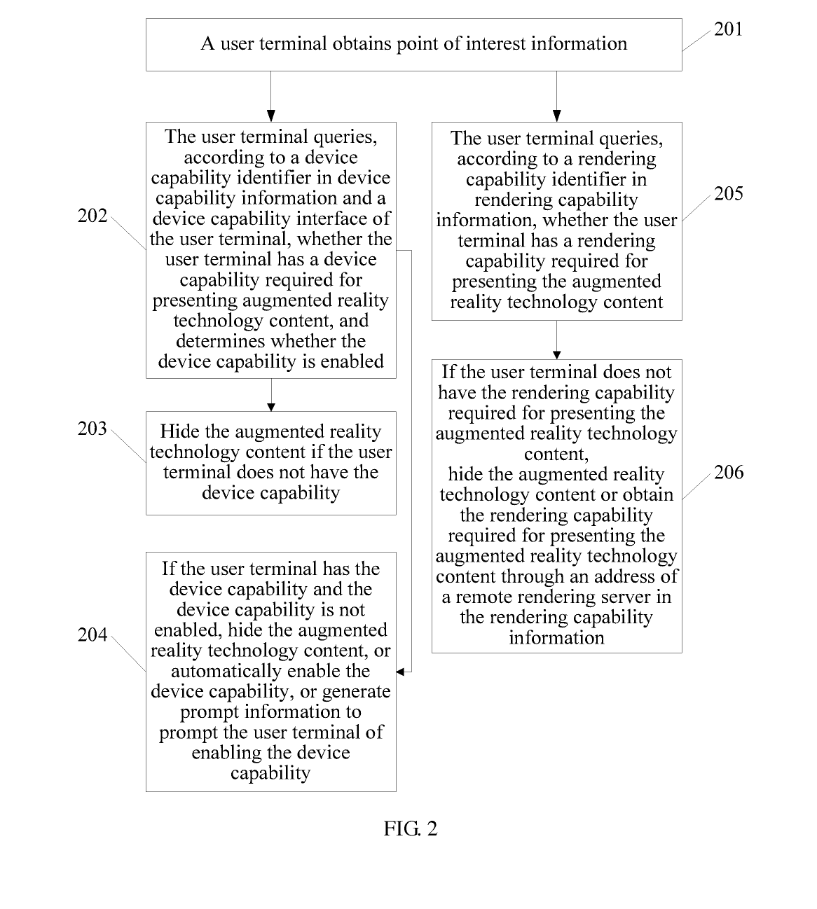

As shown in FIG. 2, a method for presenting AR content provided by another embodiment of the present invention includes:

Step 201: A user terminal obtains point of interest information. Step 202 or 205 is executed.

The point of interest information includes AR content and capability information corresponding to a capability required for presenting the AR content.

The capability information includes device capability information corresponding to a device capability required for presenting the AR content or rendering capability information corresponding to a rendering capability required for presenting the AR content.

For example, point of interest information of restaurant 1 provides a check-in function, and the check-in function needs a radio frequency identification device. In that case, the device capability information may include the information about that the check-in function needs a radio frequency identification device and prompt information of enabling the radio frequency identification device. Further, for example, the point of interest information of restaurant 1 provides a three-dimensional model display of restaurant 1, and the three-dimensional model display needs a three-dimensional imaging function. In that case, the rendering capability information may include the information about that presenting of the three-dimensional model display needs the three-dimensional imaging function and information of a remote rendering server, where the information of the remote rendering server may include an address of a server providing remote rendering, but the present invention is not limited hereto.

Specifically, obtaining point of interest information may be obtained from an internal user terminal database of the user terminal, or may be obtained by downloading from a server that saves the point of interest information, but the present invention is not limited hereto.

The database of the user terminal is downloaded, according to a user terminal demand, from the server that saves the point of interest information. For example, when a corresponding application program is installed, the user terminal downloads the application program from a server, where the application program may store a small amount of point of interest information, but the present invention is not limited hereto.

In an embodiment, a user terminal takes an image of the point of interest through a camera, positions and obtains location information of the user terminal through a global positioning system (GPS) or a base station, and uploads the image and the location information to a server. The server performs searching and matching according to the image and the location information, so as to obtain the identifier of the point of interest (for example, a name of the point of interest), obtains the point of interest information from stored point of interest information according to the identifier of the point of interest, and delivers the point of interest information to the user terminal.

Step 202: The user terminal queries, according to a device capability identifier in the device capability information and a device capability interface of the user terminal, whether the user terminal has a device capability required for presenting the AR content, and determines whether the device capability is enabled.

The device capability interface may be an interface provided by the user terminal, or a remote device management interface, such as an OMA_DM interface used by a remote server to manage a network terminal, but the present invention is not limited hereto.

Step 203: Hide the AR content if the user terminal does not have the device capability.

Step 204: If the user terminal has the device capability and the device capability is not enabled, hide the AR content, or automatically enable the device capability, or generate prompt information to prompt the user terminal to enable the device capability.

For example, the point of interest information of restaurant 1 provides the check-in function, and the check-in function needs the radio frequency identification device, but if the radio frequency identification device is not enabled, then multiple solutions may be adopted, for example, the check-in function may be hidden, so that a user does not apply the check-in function, or the radio frequency identification device is automatically enabled and the check-in function is applied after the radio frequency identification function is enabled, or a prompt information dialogue box is generated to prompt the user terminal to enable the radio frequency identification device, and the check-in function is applied after the user terminal selects to enable the radio frequency identification device, but the present invention is not limited hereto.

Step 205: The user terminal queries, according to a rendering capability identifier in the rendering capability information, whether the user terminal has the rendering capability required for presenting the AR content.

Step 206: If the user terminal does not have the rendering capability required for presenting the AR content, hide the AR content or obtain, through the address of the remote rendering server, the rendering capability required for presenting the AR content in the rendering capability information.

For example, the point of interest information of restaurant 1 provides the three-dimensional model display of restaurant 1, the three-dimensional model display needs the three-dimensional imaging function, but if the user terminal does not have the three-dimensional imaging function, then multiple solutions may be adopted, for example, the three-dimensional model display function may be hidden, so that the user does not apply the three-dimensional model display function, or through the address of the remote rendering server in the point of interest information, the three-dimensional imaging function is downloaded from the address of the remote rendering server or the three-dimensional imaging is directly performed on the address of the remote rendering server, but the present invention is not limited hereto.

In the method for presenting AR content provided by another embodiment of the present invention, point of interest information is obtained, whether a user terminal has the corresponding capability is queried according to capability information corresponding to a capability required for presenting AR content in the point of interest information, and the AR content is hidden or the capability required for presenting the AR content is obtained if the user terminal does not have the capability required for presenting the AR content. By using the method, an error does not occur during running on the user terminal after the user terminal receives the point of interest information. Compared with the prior art, the embodiment of the present invention may solve the problem that, when the user terminal that needs to present the AR content runs the point of interest information after it receives the point of interest information, an error occurs because the user terminal does not have the capability required for presenting the AR content.

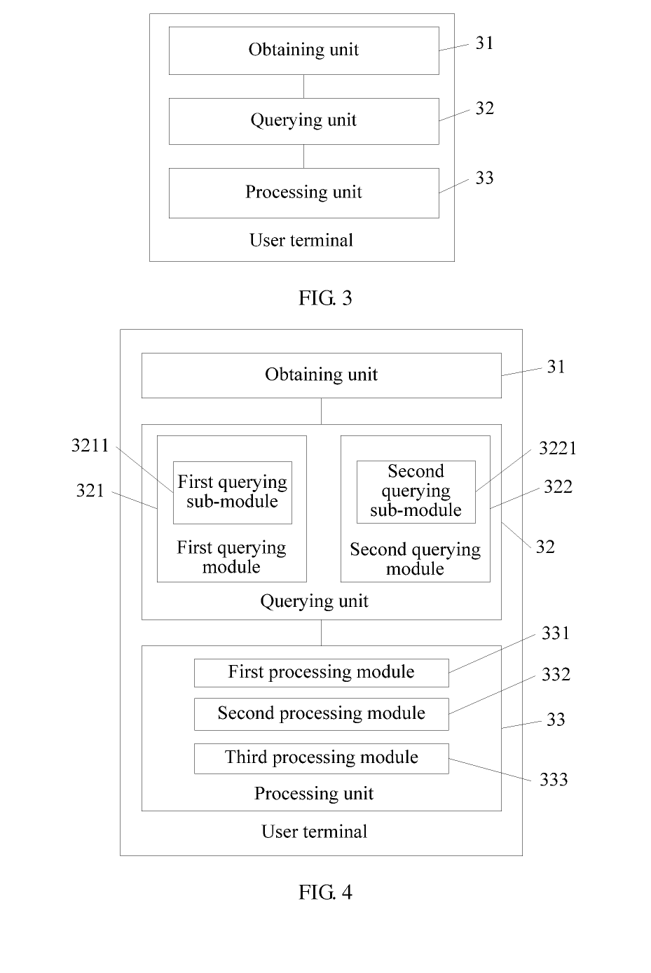

As shown in FIG. 3, a user terminal provided by an embodiment of the present invention includes: an obtaining unit 31 configured to obtain point of interest information, where the point of interest information includes AR content and capability information corresponding to a capability required for presenting the AR content; reference may be made to step 101 shown in FIG. 1 for a specific implementation manner, which is not described again herein; a querying unit 32 configured to query, according to the capability information, whether a user terminal has the capability required for presenting the AR content; reference may be made to step 102 shown in FIG. 1 for a specific implementation manner, which is not described again herein; and a processing unit 33 configured to hide the AR content or obtain the capability required for presenting the AR content if the user terminal does not have the capability required for presenting the AR content; reference may be made to step 103 shown in FIG. 1 for a specific implementation manner, which is not described again herein.

Furthermore, as shown in FIG. 4, the querying unit 32 includes: a first querying module 321 configured to query, according to device capability information, whether the user terminal has a device capability required for presenting the AR content and whether the device capability is enabled; reference may be made to step 202 shown in FIG. 2 for a specific implementation manner, which is not described again herein; and a second querying unit 322 configured to query, according to rendering capability information, whether the user terminal has a rendering capability required for presenting the AR content; reference may be made to step 205 shown in FIG. 2 for a specific implementation manner, which is not described again herein.

Furthermore, as shown in FIG. 4, the first querying module 321 includes: a first querying sub-module 3211 configured to query, according to a device capability identifier in the device capability information and a device capability interface of the user terminal, whether the user terminal has the device capability required for presenting the AR content, and determines whether the device capability is enabled; reference may be made to step 202 shown in FIG. 2 for a specific implementation manner, which is not described again herein.

The processing unit 33 includes: a first processing module 331 configured to hide the AR content if the user terminal does not have the device capability; reference may be made to step 203 shown in FIG. 2 for a specific implementation manner, which is not described again herein; and a second processing module 332 configured to: if the user terminal has the device capability and the device capability is not enabled, hide the AR content, or automatically enable the device capability, or generate prompt information to prompt the user terminal to enable the device capability; reference may be made to step 204 shown in FIG. 2 for a specific implementation manner, which is not described again herein.

Furthermore, as shown in FIG. 4, the second querying module 322 includes: a second querying sub-module 3221 configured to query, according to the rendering capability identifier, whether the user terminal has the rendering capability required for presenting the AR content; reference may be made to step 205 shown in FIG. 2 for a specific implementation manner, which is not described again herein.

The processing unit 33 further includes: a third processing module 333 configured to: if the user terminal does not have the rendering capability required for presenting the AR content, hide the AR content or obtain the rendering capability required for presenting the AR content through an address of a remote rendering server; reference may be made to step 206 shown in FIG. 2 for a specific implementation manner, which is not described again herein.

It should be noted that during practical application, the user terminal provided by the embodiment of the present invention may specifically be a computer (for example, a laptop PC), a cell phone (for example, a smartphone), a tablet PC, and the like, but the present invention is not limited hereto.

In the user terminal provided by the embodiment of the present invention, an obtaining unit obtains point of interest information, a querying unit queries, according to capability information corresponding to a capability required for presenting AR content in the point of interest information, whether a user terminal has a corresponding capability, and a processing unit hides the AR content or obtains the capability required for presenting the AR content if the user terminal does not have the capability required for presenting the AR content. Therefore, an error does not occur during running on the user terminal after the user terminal receives the point of interest information. Compared with the prior art, the embodiment of the present invention may solve the problem that, when the user terminal that needs to present the AR content runs the point of interest information after it receives the point of interest information, an error occurs because the user terminal does not have the capability required for presenting the AR content.

As shown in FIG. 5, a system for presenting AR content provided by an embodiment of the present invention includes the user terminal 41, and a server 42 configured to enable the user terminal 41 to download point of interest information. Reference may be made to the specific implementation of the user terminal 41 for a specific embodiment of the user terminal 41, which is not described again herein.

In the system for presenting AR content provided by the embodiment of the present invention, a user terminal 41 obtains point of interest information through the server 42, queries, according to capability information corresponding to a capability required for presenting AR content in the point of interest information, whether the user terminal 41 has the corresponding capability, and hides the AR content or obtains the capability required for presenting the AR content if the user terminal 41 does not have the capability required for presenting the AR content. Therefore, an error does not occur during running on the user terminal 41 after the user terminal 41 receives the point of interest information. Compared with the prior art, the embodiment of the present invention may solve the problem that, when the user terminal 41 that needs to present the AR content runs the point of interest information after it receives the point of interest information, an error occurs because the user terminal 41 does not have the capability required for presenting the AR content.

A detailed physical apparatus is provided below to explain the present invention, and details are described in the detailed explanation. However, a person skilled in the art obviously knows that the present invention may be implemented without these details, and that a well-known method, process, component, circuit, and network are not described in detail in other cases, so as to avoid making all aspects of implementation unnecessarily unclear.

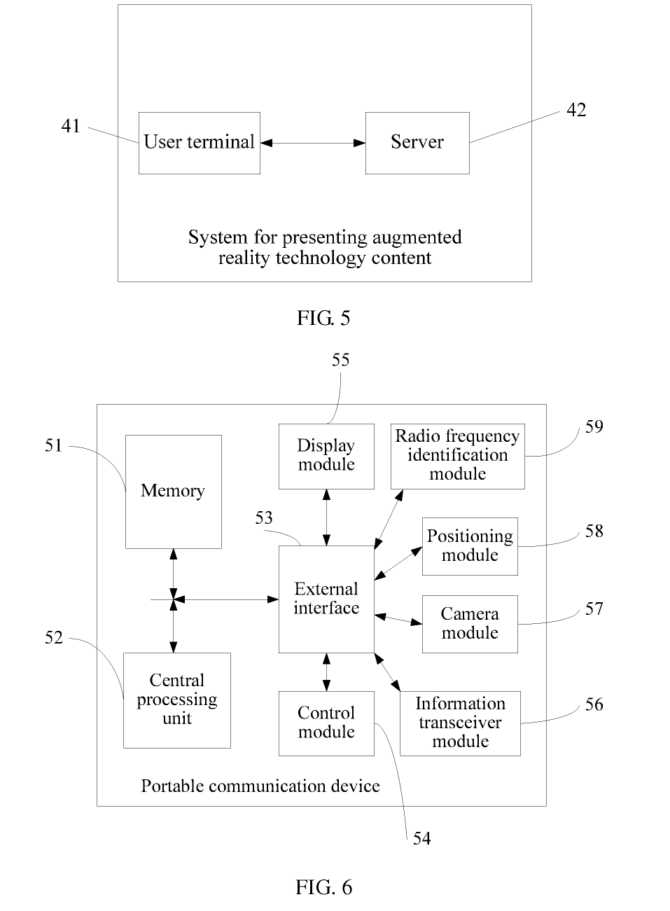

A portable communication device with a camera module is taken as an example for detailed description, as shown in FIG. 6, and the device includes: a memory 51, a central processing unit 52, an external interface 53, a control module 54, and a display module 55.

It should be understood that the portable communication device provided by this embodiment is only an example of a user terminal, the user terminal in the present invention may have more or less components than that shown in FIG. 6, and may have different arrangements or sets of the components, each component may be implemented in hardware that includes one or more signal processing and/or application-specific integrated circuit, or software, or a combination of hardware and software.

As shown in FIG. 6, the portable communication device provided by the embodiment of the present invention is described in detail below.

The portable communication device exchanges information with a server through an information transceiver module 56 connected to the external interface 53, for example, the portable communication device needs to apply an application program used to present AR content, the portable communication device downloads the application program from the server through the information transceiver module 56, where the application program may store a great amount of point of interest information that presents AR content. After processing of the central processing unit 52, the communication device stores the application program and the point of interest information in the memory 51.

When the communication device controls and applies, through the control module 54, the application program that presents the AR content, for example, shoots a point of interest through a camera module 57 connected to the external interface 53, or positions and determines the point of interest through a positioning module 58 connected to the external interface 53. In an embodiment, the communication device takes an image of the point of interest through a camera, positions and obtains location information of the user terminal through a GPS or a base station, and uploads the image and the location information to the server. The server performs searching and matching according to the image and the location information, so as to obtain an identifier of the point of interest (for example, a name of the point of interest), obtains, according to the identifier of the point of interest, the point of interest information from stored point of interest information, and delivers the point of interest information to the communication device. The point of interest information is obtained after the point of interest is sent to the central processing unit 52 to process and invoke the point of interest information in the memory 51, or the central processing unit 52 provides for the information transceiver module 56 an instruction that the point of interest is downloaded from the server.

After obtaining the point of interest information, the central processing unit 52 queries whether the portable communication device has the corresponding capability through the external interface 53 by processing and analyzing the content of the point of interest information (the point of interest information includes basic application information and rendering capability information and/or device capability information).

For example, a device capability (for example, a radio frequency identification module 59 connected to the external interface 53) is required for presenting the AR content if the radio frequency identification module 59 is not enabled, the central processing unit 52 invokes an enabling radio frequency identification identifier in the point of interest information, and displays the identifier through a display module 55 connected to the external interface 53 for prompting, or the central processing unit 52 directly enables the radio frequency identification module 59, or the central processing unit 52 hides the AR content.

Further, for example, a rendering capability (for example, a three-dimensional imaging capability) is required for presenting the AR content if there is no corresponding three-dimensional imaging capability, the central processing unit 52 invokes remote rendering capability information (for example, a connection address of a server that provides a remote rendering capability) in the point of interest information, displays, through the display module 55, the connection address of the server that provides the remote rendering capability, or the central processing unit 52 directly hides the AR content.

In the portable communication device provided by the embodiment of the present invention, a point of interest is shot by a camera module, a location of the point of interest is positioned and determined by a positioning system module, a central processing unit obtains point of interest information corresponding to an identifier of the point of interest from a memory by processing the identifier of the point of interest or by connecting to the server through the information transceiver module, the central processing unit analyzes the point of interest information and queries whether the portable communication device has a capability required for presenting the AR content, and hides the AR content or obtains the capability required for presenting the AR content if the portable communication device does not have the capability required for presenting the AR content. Therefore, an error does not occur during running on the user terminal after the user terminal receives the point of interest information. Compared with the prior art, the embodiment of the present invention may solve the problem that, when the user terminal that needs to present the AR content runs the point of interest information after it receives the point of interest information, an error occurs because the user terminal does not have the capability required for presenting the AR content.

Through the foregoing description of the embodiments, it is clear to a person skilled in the art that the present invention may be implemented by software plus necessary universal hardware, and definitely may also be implemented by hardware, but in many cases, the software implementation is preferred. Based on such an understanding, the technical solutions of the present invention essentially, or the part contributing to the prior art may be implemented in a form of a software product. The computer software product is stored in a readable storage medium, for example, a floppy disk, a hard disk, or an optical disc of the computer, and includes several instructions for instructing a computer device (which may be a personal computer, a server, or a network device) to perform the methods described in the embodiments of the present invention.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for presenting augmented reality technology (AR) content, comprising:
obtaining point of interest information, wherein the point of interest information comprises an AR content and a capability information corresponding to a capability required for presenting the AR content;
querying, according to the capability information, whether a user terminal has the capability required for presenting the AR content; and
either hiding the AR content; or
obtaining the capability for presenting the AR content when the user terminal does not have the capability for presenting the AR content.

2. The method according to claim 1, wherein the capability information comprises: a device capability information corresponding to a device capability for presenting the AR content, wherein the user terminal has the capability required for presenting the AR content when at least one of the following occurs: having the device capability that is required for presenting the AR content, where the device capability is enabled and having the rendering capability required for presenting the AR content.

3. The method according to claim 2, wherein the querying, according to the capability information, whether the user terminal has the capability required for presenting the AR content comprises at least one of the following: querying, according to the device capability information, whether the user terminal has the device capability required for presenting the AR content and whether the device capability is enabled and querying, according to the rendering capability information, whether the user terminal has the rendering capability required for presenting the AR content.

4. The method according to claim 3, wherein the device capability information comprises a device capability identifier, wherein the querying, according to the device capability information, whether the user terminal has the device capability required for presenting the AR content and whether the device capability is enabled comprises querying, according to the device capability identifier and a device capability interface of the user terminal, whether the user terminal has the device capability required for presenting the AR content, and determining whether the device is enabled, and wherein the method further comprises:
hiding the AR content when the user terminal does not have the device capability;
hiding the AR content when the user terminal has the device capability and the device capability is not enabled; and
automatically enabling the device capability.

5. The method according to claim 3, wherein the rendering capability information comprises a rendering capability identifier and a remote rendering capability information that corresponds to the rendering capability, wherein the remote rendering capability information comprises an address of a remote rendering server, wherein the querying, according to the rendering capability information, whether the user terminal has the rendering capability required for presenting the AR content comprises querying, according to the rendering capability identifier, whether the user terminal has the rendering capability required for presenting the AR content, and wherein the method further comprises: hiding the AR content when the user terminal does not have the rendering capability required for presenting the AR content.

6. A user terminal, comprising:
an obtaining unit configured to obtain point of interest information, wherein the point of interest information comprises an augmented reality technology (AR) content and a capability information corresponding to a capability required for presenting the AR content;
a querying unit configured to query, according to the capability information, whether a user terminal has the capability required for presenting the AR content; and
a processing unit configured to either hide the AR content or obtain the capability required for presenting the AR content when the user terminal does not have the capability required for presenting the AR content.

7. The user terminal according to claim 6, wherein the capability information comprises: a device capability information corresponding to a device capability for the following: presenting the AR content and rendering capability information corresponding to a rendering capability required for presenting the AR content, and wherein the querying unit comprises at least one of the following: a first querying module configured to query, according to the device capability information, whether the user terminal has the device capability required for presenting the AR content and whether the device capability is enabled; and
a second querying unit configured to query, according to the rendering capability information, whether the user terminal has the rendering capability required for presenting the AR content.

8. The user terminal according to claim 7, wherein the device capability information comprises a device capability identifier, wherein the first querying module comprises a first querying sub-module configured to: query, according to the device capability identifier and a device capability interface of the user terminal, whether the user terminal has the device capability required for presenting the AR content, and determine whether the device is enabled; and wherein the processing unit comprises:
a first processing module configured to hide the AR content when the user terminal does not have the device capability; and
a second processing module configured to: hide the AR content when the user terminal has the device capability and the device capability is not enabled, and either automatically enable the device capability or generate a prompt information to prompt the user terminal to enable the device capability.

9. The user terminal according to claim 7, wherein the rendering capability information comprises a rendering capability identifier and a remote rendering capability information that corresponds to the rendering capability, wherein the remote rendering capability information comprises an address of a remote rendering server, wherein the second querying module comprises a second querying sub-module configured to query, according to the rendering capability identifier, whether the user terminal has the rendering capability required for presenting the AR content, and wherein the processing unit comprises:
a third processing module configured to: either hide the AR content when the user terminal does not have the rendering capability required for presenting the AR content or obtain, through the address of the remote rendering server, the rendering capability required for presenting the AR content.

10. A system for presenting augmented reality technology (AR) content, comprising:
a user terminal; and
a server,
wherein the user terminal comprises:
an obtaining unit configured to obtain point of interest information, wherein the point of interest information comprises an AR content and a capability information corresponding to a capability required for presenting the AR content;
a querying unit configured to query, according to the capability information, whether a user terminal has the capability required for presenting the AR content; and
a processing unit configured to either hide the AR content or obtain the capability required for presenting the AR content when the user terminal does not have the capability required for presenting the AR content, and
wherein the server is configured to enable the user terminal to download a point of interest information.

11. The method according to claim 1, wherein the capability information comprises: a rendering capability information corresponding to a rendering capability for presenting the AR content, wherein the user terminal has the capability required for presenting the AR content when at least one of the following occurs: having the device capability that is required for presenting the AR content, where the device capability is enabled and having the rendering capability required for presenting the AR content.

12. The method according to claim 3, wherein the device capability information comprises a device capability identifier, wherein the querying, according to the device capability information, whether the user terminal has the device capability required for presenting the AR content and whether the device capability is enabled comprises querying, according to the device capability identifier and a device capability interface of the user terminal, whether the user terminal has the device capability required for presenting the AR content, and determining whether the device is enabled, and wherein the method further comprises:
hiding the AR content when the user terminal does not have the device capability;
hiding the AR content when the user terminal has the device capability and the device capability is not enabled; and
generating a prompt information to prompt the user terminal to enable the device capability.

13. The method according to claim 3, wherein the rendering capability information comprises a rendering capability identifier and a remote rendering capability information that corresponds to the rendering capability, wherein the remote rendering capability information comprises an address of a remote rendering server, wherein the querying, according to the rendering capability information, whether the user terminal has the rendering capability required for presenting the AR content comprises querying, according to the rendering capability identifier, whether the user terminal has the rendering capability required for presenting the AR content, and wherein the method further comprises: obtaining, through the address of the remote rendering server, the rendering capability required for presenting the AR content.
